(19) United States
(12) Patent Application Publication
(10) Pub. No.: US 2024/0229541 A1
(43) Pub. Date: Jul. 11, 2024

(54) SILL CLEAT FOR FENESTRATION SYSTEMS

(71) Applicant: Andersen Corporation, Bayport, MN (US)

(72) Inventors: Justin Michael Depew, Stillwater, MN (US); Craig Michael Johnson, North Oaks, MN (US)

(21) Appl. No.: 18/392,882

(22) Filed: Dec. 21, 2023

Related U.S. Application Data
(60) Provisional application No. 63/438,163, filed on Jan. 10, 2023.

(51) Int. Cl. E06B 1/60; E06B 1/70

(52) U.S. Cl. CPC E06B 1/6053; E06B 1/702

(57) ABSTRACT

Embodiments herein relate to sill cleats for fenestration systems. In an embodiment, a fenestration system is included having a frame assembly including a sill with a bottom side. The bottom side can include a first edge projection, a second edge projection, and can define a cavity. The system can also include a sill cleat with a first angled surface configured to engage the first edge projection upon movement of the sill in a first direction. The sill cleat can also include a second angled surface disposed on an opposite side of the sill cleat from the first angled surface configured to engage the second edge projection upon movement of the sill in a second direction. Other embodiments are also included herein.

This application claims the benefit of U.S. Provisional Application No. 63/438,163, filed Jan. 10, 2023, the content of which is herein incorporated by reference in its entirety.

### FIELD

Embodiments herein relate to sill cleats for fenestration systems.

### BACKGROUND

Fenestration systems can include windows, patio doors, entry doors, and the like. In general, many frames for fenestrations systems can include a head jamb at the top, side jambs, and a sill at the bottom. Other frame components can also be included. Regardless, the fenestration system may be subject to forces such as those generated by the wind on the fenestration (known as a “wind load”). The wind load can include forces pushing in on the fenestration system from the exterior. In some cases, depending on relative air pressure between the interior and exterior of a building, forces can also push outward on the fenestration. It is desirable for fenestration systems to be sufficiently strong and anchored to withstand such loads.

### SUMMARY

Embodiments herein relate to sill cleats for fenestration systems. In a first aspect, a fenestration system is included having a frame assembly. The frame assembly can include a sill. The sill can include a bottom side. The bottom side can include a first edge projection and a second edge projection. The bottom side of the sill can define a cavity. A gap between the first edge projection and the second edge projection provides access to the cavity. The system can also include a sill cleat. The sill cleat can include a first angled surface and can be configured to engage the first edge projection upon movement of the sill in a first direction. The sill cleat can also include a second angled surface. The second angled surface can be disposed on an opposite side of the sill cleat from the first angled surface. The second angled surface can be configured to engage the second edge projection upon movement of the sill in a second direction. The sill cleat can extend at least part way through the gap between the first edge projection and the second edge projection.

In a second aspect, in addition to one or more of the preceding or following aspects, or in the alternative to some aspects, the first angled surface can be configured to engage the first edge projection upon movement of the sill in the first direction a distance of 0.1 to 0.3 inches.

In a third aspect, in addition to one or more of the preceding or following aspects, or in the alternative to some aspects, the first angled surface can be configured to engage the first edge projection upon movement of the sill in the first direction a distance of about 0.175 inches.

In a fourth aspect, in addition to one or more of the preceding or following aspects, or in the alternative to some aspects, the second angled surface can be configured to engage the second edge projection upon movement of the sill in the second direction a distance of 0.1 to 0.3 inches.

In a fifth aspect, in addition to one or more of the preceding or following aspects, or in the alternative to some aspects, the second angled surface can be configured to engage the second edge projection upon movement of the sill in the second direction a distance of about 0.175 inches.

In a sixth aspect, in addition to one or more of the preceding or following aspects, or in the alternative to some aspects, further can include a polymeric composition, wherein the polymeric composition can be disposed adjacent to the first angled surface and the second angled surface.

In a seventh aspect, in addition to one or more of the preceding or following aspects, or in the alternative to some aspects, the polymeric composition can include a silicone sealant.

In an eighth aspect, in addition to one or more of the preceding or following aspects, or in the alternative to some aspects, the first angled surface can be angled from 35 to 55 degrees with respect to a bottom surface of the sill such that a top of the first angled surface can be wider than a bottom of the first angled surface.

In a ninth aspect, in addition to one or more of the preceding or following aspects, or in the alternative to some aspects, the second angled surface can be angled from 35 to 55 degrees with respect to a bottom surface of the sill.

In a tenth aspect, in addition to one or more of the preceding or following aspects, or in the alternative to some aspects, the fenestration system can be a door assembly.

In an eleventh aspect, in addition to one or more of the preceding or following aspects, or in the alternative to some aspects, the fenestration system can be a window assembly.

In a twelfth aspect, in addition to one or more of the preceding or following aspects, or in the alternative to some aspects, the sill cleat can have a profile height of about ⅜ inches or less.

In a thirteenth aspect, in addition to one or more of the preceding or following aspects, or in the alternative to some aspects, the sill cleat can be formed of an injection molded polymer.

In a fourteenth aspect, in addition to one or more of the preceding or following aspects, or in the alternative to some aspects, the sill cleat can be formed of a metal.

In a fifteenth aspect, in addition to one or more of the preceding or following aspects, or in the alternative to some aspects, the sill cleat can be formed of aluminum. In a sixteenth aspect, in addition to one or more of the preceding or following aspects, or in the alternative to some aspects, the sill cleat can be at least 10 inches long.

In a seventeenth aspect, in addition to one or more of the preceding or following aspects, or in the alternative to some aspects, a bottom surface of the sill cleat defines one or more feet.

In an eighteenth aspect, in addition to one or more of the preceding or following aspects, or in the alternative to some aspects, the sill cleat can be divided into a plurality of discrete pieces.

In a nineteenth aspect, in addition to one or more of the preceding or following aspects, or in the alternative to some aspects, the sill cleat can have a substantially rectangular perimeter.

In a twentieth aspect, in addition to one or more of the preceding or following aspects, or in the alternative to some aspects, the sill cleat can have a substantially circular perimeter.

In a twenty-first aspect, in addition to one or more of the preceding or following aspects, or in the alternative to some aspects, the sill cleat can have a curvilinear perimeter.

In a twenty-second aspect, a method of securing a sill of a fenestration system can be included. The method can include attaching a sill cleat to a base structure. The sill cleat can include a first angled surface and a second angled surface. The method can further include mounting a sill assembly over the sill cleat. The sill assembly can include a bottom surface. The bottom surface can include a first edge projection and a second edge projection. The bottom surface can define a cavity. The sill cleat can fit within a gap between the first edge projection and the second edge projection.

In a twenty-third aspect, in addition to one or more of the preceding or following aspects, or in the alternative to some aspects, the first angled surface can be configured to engage the first edge projection upon movement of the sill assembly in a first direction a distance of 0.1 to 0.3 inches.

In a twenty-fourth aspect, in addition to one or more of the preceding or following aspects, or in the alternative to some aspects, the first angled surface can be angled from 35 to 55 degrees with respect to a bottom surface of the sill assembly such that a top of the first angled surface can be wider than a bottom of the first angled surface.

In a twenty-fifth aspect, in addition to one or more of the preceding or following aspects, or in the alternative to some aspects, the second angled surface can be configured to engage the second edge projection upon movement of the sill assembly in a second direction a distance of 0.1 to 0.3 inches.

In a twenty-sixth aspect, in addition to one or more of the preceding or following aspects, or in the alternative to some aspects, the second angled surface can be angled from 35 to 55 degrees with respect to a bottom surface of the sill assembly.

In a twenty-seventh aspect, a fenestration system can be included having a frame assembly. The frame assembly can include a sill. The sill can include a bottom surface. The bottom surface can include a first edge projection and a second edge projection. The first edge projection can include a first angled surface. The second edge projection can include a second angled surface. The bottom surface can define a cavity. A gap between the first edge projection and the second edge projection provides access to the cavity. The system can include a sill cleat, wherein the sill cleat extends part way through the gap. The first angled surface of the first edge projection can be configured to engage the sill cleat upon movement of the sill in a first direction and the second angled surface of the second edge projection can be configured to engage the sill cleat upon movement of the sill in a second direction, wherein the first direction can be opposite the second direction.

In a twenty-eighth aspect, in addition to one or more of the preceding or following aspects, or in the alternative to some aspects, the first angled surface can be configured to engage the sill cleat upon movement of the sill in the first direction a distance of about 0.175 inches.

In a twenty-ninth aspect, in addition to one or more of the preceding or following aspects, or in the alternative to some aspects, the second angled surface can be configured to engage the sill cleat upon movement of the sill in the second direction a distance of about 0.175 inches.

In a thirtieth aspect, in addition to one or more of the preceding or following aspects, or in the alternative to some aspects, the system can further include a polymeric composition, wherein the polymeric composition can be disposed adjacent to the first angled surface and the second angled surface.

In a thirty-first aspect, in addition to one or more of the preceding or following aspects, or in the alternative to some aspects, the polymeric composition can include a silicone sealant.

In a thirty-second aspect, in addition to one or more of the preceding or following aspects, or in the alternative to some aspects, the first angled surface can be angled from 35 to 55 degrees with respect to a bottom surface of the sill.

In a thirty-third aspect, in addition to one or more of the preceding or following aspects, or in the alternative to some aspects, the second angled surface can be angled from 35 to 55 degrees with respect to a bottom surface of the sill.

In a thirty-fourth aspect, in addition to one or more of the preceding or following aspects, or in the alternative to some aspects, the fenestration system can be a door assembly.

In a thirty-fifth aspect, in addition to one or more of the preceding or following aspects, or in the alternative to some aspects, the fenestration system can be a window assembly.

In a thirty-sixth aspect, in addition to one or more of the preceding or following aspects, or in the alternative to some aspects, the sill cleat can have a profile height of about ⅜ inches or less.

In a thirty-seventh aspect, in addition to one or more of the preceding or following aspects, or in the alternative to some aspects, the sill cleat can be formed of an injection molded polymer.

In a thirty-eighth aspect, in addition to one or more of the preceding or following aspects, or in the alternative to some aspects, the sill cleat can be formed of a metal.

In a thirty-ninth aspect, in addition to one or more of the preceding or following aspects, or in the alternative to some aspects, the sill cleat can be formed of aluminum.

In a fortieth aspect, in addition to one or more of the preceding or following aspects, or in the alternative to some aspects, the sill cleat can be at least 10 inches long.

In a forty-first aspect, in addition to one or more of the preceding or following aspects, or in the alternative to some aspects, a bottom surface of the sill cleat defines one or more feet.

In a forty-second aspect, a method of securing a sill of a fenestration system is included. The method can include attaching a sill cleat to a base structure and mounting a sill assembly over the sill cleat. The sill assembly can include a bottom surface, the bottom surface can include a first edge projection and a second edge projection. The first edge projection can include a first angled surface. The second edge projection can include a second angled surface. The bottom surface of the sill assembly can define a cavity. The sill cleat fits within a gap between the first edge projection and the second edge projection.

In a forty-third aspect, in addition to one or more of the preceding or following aspects, or in the alternative to some aspects, the first angled surface can be configured to engage the sill cleat upon movement of the sill assembly in a first direction a distance of 0.1 to 0.3 inches.

In a forty-fourth aspect, in addition to one or more of the preceding or following aspects, or in the alternative to some aspects, the first angled surface can be angled from 35 to 55 degrees with respect to a bottom surface of the sill assembly.

In a forty-fifth aspect, in addition to one or more of the preceding or following aspects, or in the alternative to some aspects, the second angled surface can be configured to engage the sill cleat upon movement of the sill assembly in a second direction a distance of 0.1 to 0.3 inches.

In a forty-sixth aspect, in addition to one or more of the preceding or following aspects, or in the alternative to some aspects, the second angled surface can be angled from 35 to 55 degrees with respect to a bottom surface of the sill assembly.

In a forty-seventh aspect, a fenestration system can be included having a frame assembly. The frame assembly can include a sill with a bottom surface. The bottom surface can include a first edge projection and a second edge projection. The bottom surface defines a cavity. A gap between the first edge projection and the second edge projection provides access to the cavity. The system further includes a sill cleat. The sill cleat can include a first angled surface that can be configured to engage the first edge projection upon movement of the sill in a first direction. The sill cleat extends part way through the gap.

In a forty-eighth aspect, in addition to one or more of the preceding or following aspects, or in the alternative to some aspects, the first angled surface can be configured to engage the first edge projection upon movement of the sill in the first direction a distance of 0.1 to 0.3 inches.

In a forty-ninth aspect, in addition to one or more of the preceding or following aspects, or in the alternative to some aspects, the first angled surface can be configured to engage the first edge projection upon movement of the sill in the first direction a distance of about 0.175 inches.

In a fiftieth aspect, in addition to one or more of the preceding or following aspects, or in the alternative to some aspects, further can include a polymeric composition, wherein the polymeric composition can be disposed adjacent to the first angled surface.

In a fifty-first aspect, in addition to one or more of the preceding or following aspects, or in the alternative to some aspects, the polymeric composition can include a silicone sealant.

In a fifty-second aspect, in addition to one or more of the preceding or following aspects, or in the alternative to some aspects, the first angled surface can be angled from 35 to 55 degrees with respect to a bottom surface of the sill such that a top of the first angled surface can be wider than a bottom of the first angled surface.

In a fifty-third aspect, in addition to one or more of the preceding or following aspects, or in the alternative to some aspects, the fenestration system can be a door assembly.

In a fifty-fourth aspect, in addition to one or more of the preceding or following aspects, or in the alternative to some aspects, the fenestration system can be a window assembly.

In a fifty-fifth aspect, in addition to one or more of the preceding or following aspects, or in the alternative to some aspects, the sill cleat can have a profile height of about ⅜ inches or less.

In a fifty-sixth aspect, in addition to one or more of the preceding or following aspects, or in the alternative to some aspects, the sill cleat can be formed of an injection molded polymer.

In a fifty-seventh aspect, in addition to one or more of the preceding or following aspects, or in the alternative to some aspects, the sill cleat can be formed of a metal.

In a fifty-eighth aspect, in addition to one or more of the preceding or following aspects, or in the alternative to some aspects, the sill cleat can be formed of aluminum.

In a fifty-ninth aspect, in addition to one or more of the preceding or following aspects, or in the alternative to some aspects, the sill cleat can be at least 10 inches long.

In a sixtieth aspect, in addition to one or more of the preceding or following aspects, or in the alternative to some aspects, a bottom surface of the sill cleat defines one or more feet.

In a sixty-first aspect, in addition to one or more of the preceding or following aspects, or in the alternative to some aspects, the sill cleat can be divided into a plurality of discrete pieces.

In a sixty-second aspect, in addition to one or more of the preceding or following aspects, or in the alternative to some aspects, the sill cleat can have a substantially rectangular perimeter.

In a sixty-third aspect, in addition to one or more of the preceding or following aspects, or in the alternative to some aspects, the sill cleat can have a substantially circular perimeter.

In a sixty-fourth aspect, in addition to one or more of the preceding or following aspects, or in the alternative to some aspects, the sill cleat can have a curvilinear perimeter.

In a sixty-fifth aspect, a fenestration system can be included having a frame assembly including a sill. The sill can include a bottom surface including a first edge projection and a second edge projection. The bottom surface can define a cavity. A gap between the first edge projection and the second edge projection provides access to the cavity. The system includes a sill cleat. The sill cleat can include a first undercut portion. The first undercut portion can be configured to engage the first edge projection upon movement of the sill in a first direction. The sill cleat can also include a second undercut portion. The second undercut portion can be disposed on an opposite side of the sill cleat from the first undercut portion. The second undercut portion can be configured to engage the second edge projection upon movement of the sill in a second direction opposite the first direction. The sill cleat extends part way through the gap.

In a sixty-sixth aspect, in addition to one or more of the preceding or following aspects, or in the alternative to some aspects, the first undercut portion can be configured to engage the first edge projection upon movement of the sill in the first direction a distance of 0.1 to 0.3 inches.

In a sixty-seventh aspect, in addition to one or more of the preceding or following aspects, or in the alternative to some aspects, the second undercut portion can be configured to engage the second edge projection upon movement of the sill in the second direction a distance of 0.1 to 0.3 inches.

In a sixty-eighth aspect, in addition to one or more of the preceding or following aspects, or in the alternative to some aspects, the system can further include a polymeric composition, wherein the polymeric composition can be disposed adjacent to the first undercut portion and the second undercut portion.

In a sixty-ninth aspect, in addition to one or more of the preceding or following aspects, or in the alternative to some aspects, the polymeric composition can include a silicone sealant.

In a seventieth aspect, in addition to one or more of the preceding or following aspects, or in the alternative to some aspects, the fenestration system can be a door assembly.

In a seventy-first aspect, in addition to one or more of the preceding or following aspects, or in the alternative to some aspects, the fenestration system can be a window assembly.

In a seventy-second aspect, in addition to one or more of the preceding or following aspects, or in the alternative to some aspects, the sill cleat can have a profile height of about ⅜ inches or less.

In a seventy-third aspect, in addition to one or more of the preceding or following aspects, or in the alternative to some aspects, the sill cleat can be formed of an injection molded polymer.

In a seventy-fourth aspect, in addition to one or more of the preceding or following aspects, or in the alternative to some aspects, the sill cleat can be formed of a metal.

In a seventy-fifth aspect, in addition to one or more of the preceding or following aspects, or in the alternative to some aspects, the sill cleat can be formed of aluminum.

In a seventy-sixth aspect, in addition to one or more of the preceding or following aspects, or in the alternative to some aspects, the sill cleat can be at least 10 inches long.

In a seventy-seventh aspect, in addition to one or more of the preceding or following aspects, or in the alternative to some aspects, a bottom surface of the sill cleat defines one or more feet.

In a seventy-eighth aspect, in addition to one or more of the preceding or following aspects, or in the alternative to some aspects, the sill cleat can be divided into a plurality of discrete pieces.

In a seventy-ninth aspect, in addition to one or more of the preceding or following aspects, or in the alternative to some aspects, the sill cleat can have a substantially rectangular perimeter.

In an eightieth aspect, in addition to one or more of the preceding or following aspects, or in the alternative to some aspects, the sill cleat can have a substantially circular perimeter.

In an eighty-first aspect, in addition to one or more of the preceding or following aspects, or in the alternative to some aspects, the sill cleat can have a curvilinear perimeter.

This summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope herein is defined by the appended claims and their legal equivalents.

### BRIEF DESCRIPTION OF THE FIGURES

Aspects may be more completely understood in connection with the following figures (FIGS.), in which:

FIG. 1 is a front elevation view of a fenestration system in accordance with various embodiments herein.

FIG. 2 is a front elevation view of another type of fenestration system in accordance with various embodiments herein.

FIG. 3 is a schematic side view of components of a fenestration system in accordance with various embodiments herein.

FIG. 4 is a perspective view of a sill cleat in accordance with various embodiments herein.

FIG. 5 is a cross-sectional view of a sill cleat as taken along line 5-5′ of FIG. 4 in accordance with various embodiments herein.

FIG. 6 is a schematic side view of components of a fenestration system in accordance with various embodiments herein.

FIG. 7 is a schematic side view of components of a fenestration system in accordance with various embodiments herein.

FIG. 8 is a schematic side view of components of a fenestration system in accordance with various embodiments herein.

FIG. 9 is a schematic side view of components of a fenestration system in accordance with various embodiments herein.

FIG. 10 is a schematic side view of components of a fenestration system in accordance with various embodiments herein.

FIG. 11 is a schematic side view of components of a fenestration system in accordance with various embodiments herein.

FIG. 12 is a schematic side view of components of a fenestration system in accordance with various embodiments herein.

FIG. 13 is a plan view of a sill cleat in accordance with various embodiments herein.

FIG. 14 is a plan view of a sill cleat in accordance with various embodiments herein.

FIG. 15 is a plan view of a sill cleat in accordance with various embodiments herein.

FIG. 16 is a cross-sectional view of a sill cleat in accordance with various embodiments herein.

FIG. 17 is a plan view of a sill cleat in accordance with various embodiments herein.

FIG. 18 is a plan view of a sill cleat in accordance with various embodiments herein.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DETAILED DESCRIPTION

As referenced above, the forces on a fenestration system can include wind load forces pushing in from the exterior as well as forces pushing outward.

Embodiments herein allow for fenestration systems to be anchored to withstand the forces thereon. Embodiments herein specifically include sill cleats for fenestration systems. More specifically, sill cleats herein can be used to anchor the sill of a fenestration system to one or more underlying structural components such as a rough opening, a subfloor, a concrete slab, a rim joist or the like. Sill cleats herein allow for both easy installation of the fenestration system as well as limit the amount of movement of the sill in exterior to interior and interior to exterior directions. As such, sill cleats here can provide a secure and easy to install anchoring system for fenestration systems.

As an example, a fenestration system herein can include a frame assembly. The frame assembly can include a sill with a bottom side including a first edge projection and a second edge projection. The bottom side can define a cavity wherein a gap between the first edge projection and the second edge projection provides access to the cavity. A sill cleat can include a first angled surface, wherein the first angled surface can be configured to engage the first edge projection upon movement of the sill in a first direction. The sill cleat can also include a second angled surface, wherein the second angled surface can be disposed on an opposite side of the sill cleat from the first angled surface and the second angled surface can be configured to engage the second edge projection upon movement of the sill in a second direction opposite the first direction. The sill cleat can extend at least part way through the gap when fenestration system is installed.

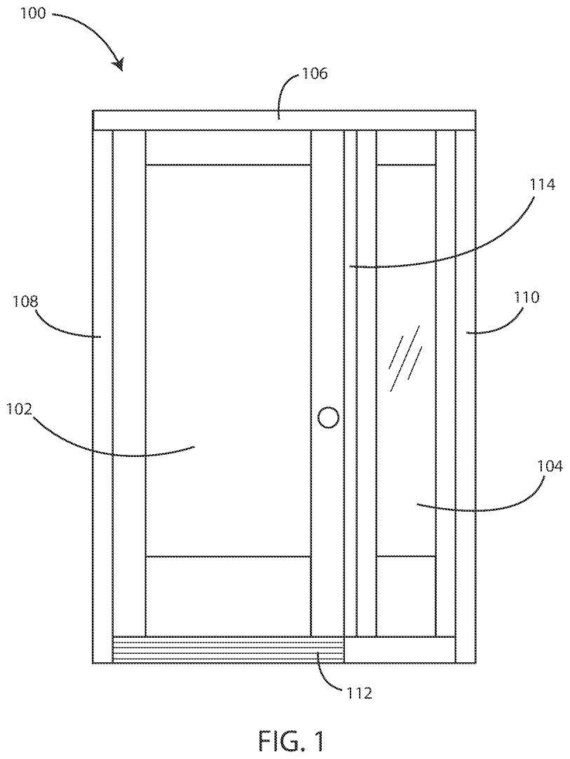

Referring now to FIG. 1, a front elevation view of a fenestration system 100 is shown in accordance with various embodiments herein. In this example, the fenestration system 100 includes an entry door 102. However, fenestration systems herein can also include windows and patio doors. In this example, the fenestration system 100 also includes a side light 104, however some fenestrations may not include a side light. A frame assembly for the fenestration system 100 includes a head jamb 106, a first side jamb 108, a second side jamb 110, and a sill assembly 112. In this example, the frame assembly also includes a mull post 114. Other frame components can also be included with embodiments herein.

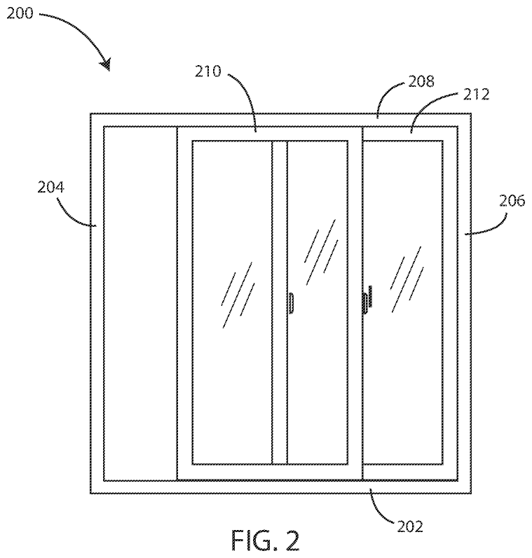

FIG. 1 shows an entry door system, but it will be appreciated that other types of fenestration systems are also included herein, such as window systems. Referring now to FIG. 2, a front elevation view is shown of another type of fenestration system in accordance with various embodiments herein. Specifically, FIG. 2 shows a window system 200 in the form of a gliding window. The window system 200 can include a window sill 202, side jambs 204, 206, and a head jamb 208. The window system 200 can also include a first sash 210 and a second sash 212. Components herein such as sill cleats can be used to anchor the window sill 202 to an underlying structural component such as a rough opening (not shown in this view).

Referring now to FIG. 3, a schematic side view of some components of a fenestration system is shown in accordance with various embodiments herein. This view is consistent with a door system. However, similar features can also be included with window systems. In this view, a sill cleat 302 is shown along with a sill assembly 112. A bottom side of the sill assembly includes a first edge projection 308 and a second edge projection 310. The bottom side of the sill assembly can fit against an underlying base structure 306 of a building such as a rough opening, a subfloor, a rim joist, or the like. The bottom side also includes a cavity 312. FIG. 3 shows the sill assembly 112 sitting on a base structure 306. In operation, the sill cleat 302 can fit into the cavity 312. For example, the sill cleat 302 can extend at least part way through a gap between the first edge projection 308 and the second edge projection 310 that provides access to the cavity 312. Once the sill cleat 302 is in position, the first edge projection 308 and the second edge projection 310 can interface with the sill cleat 302 in order to limited movement of the sill assembly 112 in either direction along an axis extending between the exterior side of the fenestration assembly and the interior side of the fenestration assembly.

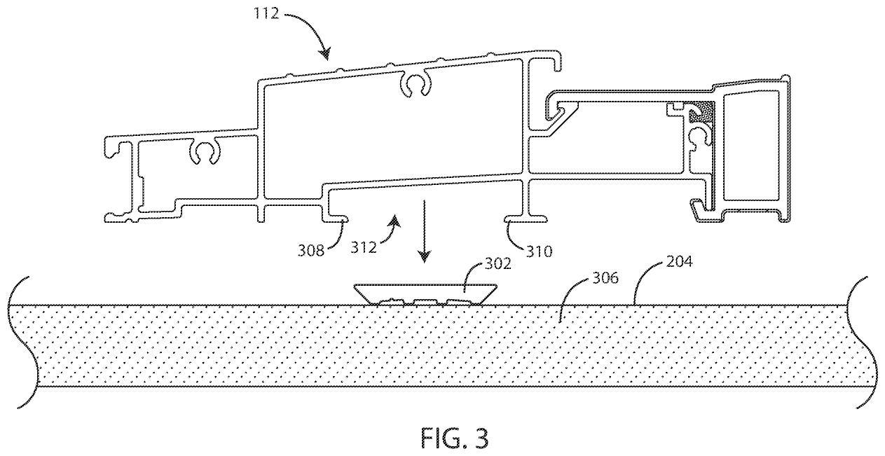

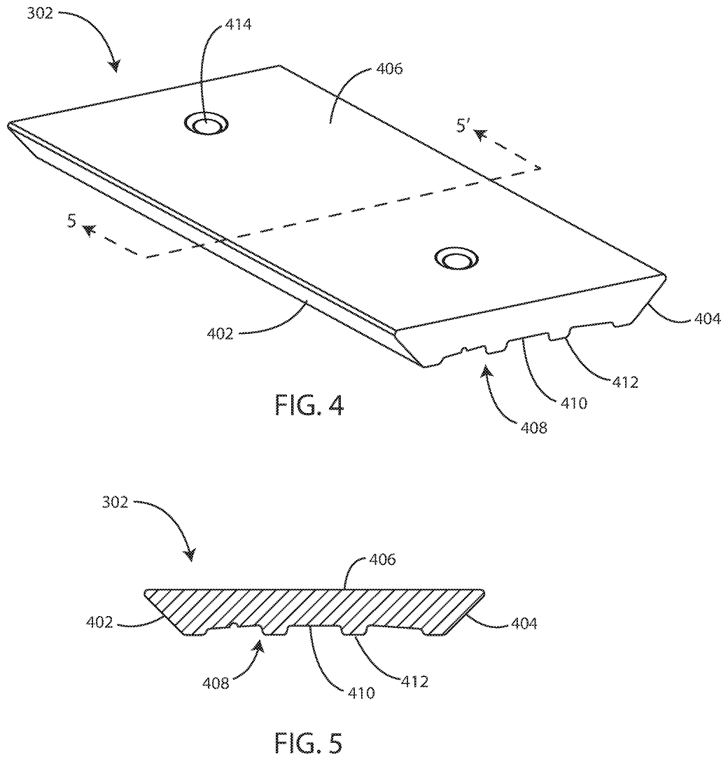

Referring now to FIG. 4, a perspective view of a sill cleat 302 is shown in accordance with various embodiments herein. The sill cleat 302 includes a first angled surface 402 and a second angled surface 404. The sill cleat 302 also includes a top surface 406. In some embodiments, the top surface 406 can define one or more fastener apertures 414. The sill cleat 302 also includes a bottom surface 408. The bottom surface 408 can define various features. For example, the bottom surface 408 can include one or more channels 410 and feet 412. While not intending to be bound by theory, the presence of the feet 412 can allow the sill cleat 302 to exert a better grip on the structure below the sill cleat 302 when installed. The feet 412 can also provide point contact to prevent rocking of the sill cleat 302 if the surface below isn't flat or includes other materials such as a rough opening that might include flashing tape. However, in other embodiments, the cleat bottom surface 408 can be substantially flat.

In various embodiments, the first angled surface 402 can be configured to engage a first edge projection 308 (shown in FIG. 3) upon movement of a sill in a first direction. For example, in various embodiments the first angled surface 402 can be configured to engage a first edge projection of the sill assembly upon movement of the sill assembly in a first direction a distance of 0.1 to 0.3 inches, or about 0.175 inches. In various embodiments, the first angled surface 402 can be angled from about 35 to about 55 degrees with respect to a horizontal plane (or a bottom side of the sill or a plane defined by a bottom side of the sill) such that a top of a first angled surface 402 is wider than a bottom of the first angled surface 402. Similarly, in various embodiments, the second angled surface 404 can be configured to engage a second edge projection 310 (shown in FIG. 3) upon movement of a sill in a second direction. For example, the second angled surface 404 can be configured to engage a second edge projection 310 upon movement of a sill in a second direction a distance of 0.1 to 0.3 inches, or about 0.175 inches. In various embodiments, the second angled surface 404 can be angled from 35 to 55 degrees with respect to a horizontal plane (or a bottom side of a sill). In various embodiments, the second angled surface 404 can be disposed on an opposite side of a sill cleat 302 from the first angled surface 402.

Referring now to FIG. 5, a cross-sectional view of a sill cleat 302 as taken along line 5-5′ of FIG. 4 is shown in accordance with various embodiments herein. The sill cleat 302 includes a first angled surface 402 and a second angled surface 404. In various embodiments, the angled surfaces can include a substantially flat portion forming a structure like an inverted ramp. In various embodiments, the flat portion of the angled surface can make up at least 10, 20, 30, 40, 50, 60, 70, 80, or 90 percent or more of the angled surface, or an amount falling within a range between any of the foregoing. However, in some embodiments, the angled surface can exhibit a degree of curvature. As before, the sill cleat 302 also includes a top surface and a bottom surface 408. The bottom surface 408 includes channels 410 and feet 412.

In various embodiments, the sill cleat 302 has a profile height (e.g., bottom to top) that is relatively short to allow easy installation of the fenestration system. If the sill cleat 302 is too tall, it can make it difficult to fit the frame into a rough opening of a structure. In some embodiments, the sill cleat 302 has a profile height of ⅛^{th} of an inch to 1 inch. In some embodiments, the sill cleat 302 has a profile height of about ⅜ths of an inch or less. In some embodiments, the sill cleat 302 has a profile height of about 3/16ths of an inch or less. In some embodiments, the sill cleat 302 has a profile height of about ⅙th of an inch or less.

The sill cleat 302 can be formed of various materials including, but not limited to, metals, polymers, composites, and the like. In some embodiments, the sill cleat 302 can be formed of an injection molded polymer. In some embodiments, the sill cleat 302 can be formed of a metal. In some embodiments, the sill cleat 302 can be formed of aluminum. In some embodiments, the sill cleat 302 can be an extrusion or pultrusion. Many different materials are contemplated herein for the sill cleat 302.

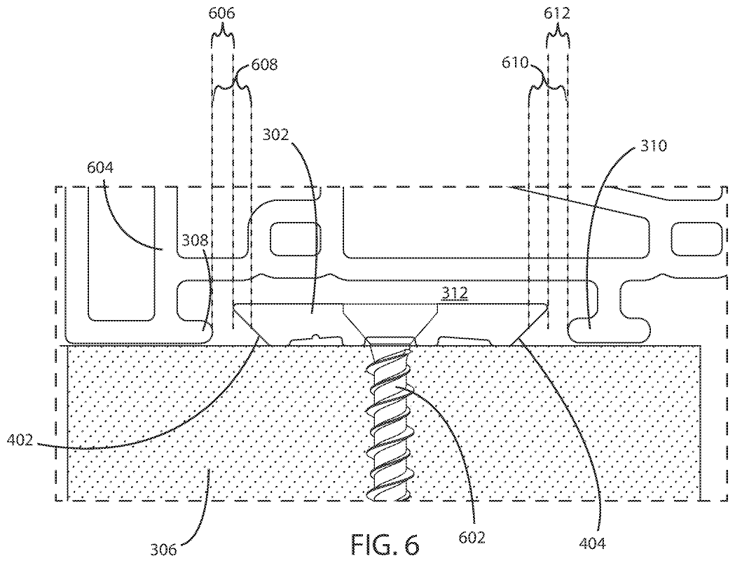

Referring now to FIG. 6, a schematic side view of components of a fenestration system 100 is shown in accordance with various embodiments herein. In this example, the fenestration system 100 can be a window system, however similar features can be used in the case of a door system. As before, the sill cleat 302 includes a first angled surface 402 and a second angled surface 404. The fenestration system also includes a fastener 602 securing the sill cleat 302 down to a base structure 306. The type of fastener used is not particularly limited, but can include screws, nails, staples, bolts, pins, rivets, or other mechanical fasteners, and/or adhesives, and the like. In this example, the sill assembly can include an extrusion 604 which defines a first edge projection 308, a second edge projection 310, and a cavity 312.

The width of the sill cleat 302 and the distance between the first edge projection 308 and the second edge projection 310 can be selected to provide a desired insertion clearance gap (e.g., referring to when the sill cleat 302 is passed into the cavity 312 by passing through the gap between the first edge projection 308 and the second edge projection 310. As such, the fenestration system includes an exterior insertion clearance gap 606 and an interior insertion clearance gap 612. If the insertion clearance gaps are too small, it can make installing the sill onto the sill cleat difficult. Conversely, if the gaps are too large, then the sill may be able to move too far before being constrained by the sill cleat.

When the fenestration system is installed over the sill cleat 302, the sill assembly can typically move a short distance before the edge projections engage with the sill cleat stopping further movement. As such, the fenestration system includes an exterior side movement gap 608 and an interior side movement gap 610. In various embodiments, gaps 608, 610 can be less than 1, ⅞^{th}, ¾, ⅝^{th}, ½, ⅜^{th}, ¼, ⅛^{th}, 1/16^{th}, or 1/32^{nd} of an inch, or an amount falling within a range between any of the foregoing.

In various embodiments, the first angled surface 402 can be configured to engage the first edge projection 308 upon movement of the sill in the first direction a distance of 0.1 to 0.3 inches. In various embodiments, the first angled surface 402 can be configured to engage the first edge projection 308 upon movement of the sill in the first direction a distance of about 0.175 inches.

In various embodiments, the second angled surface 404 can be configured to engage the second edge projection 310 upon movement of the sill in the second direction a distance of 0.1 to 0.3 inches. In various embodiments, the second angled surface 404 can be configured to engage the second edge projection 310 upon movement of the sill in the second direction a distance of 0.175 inches.

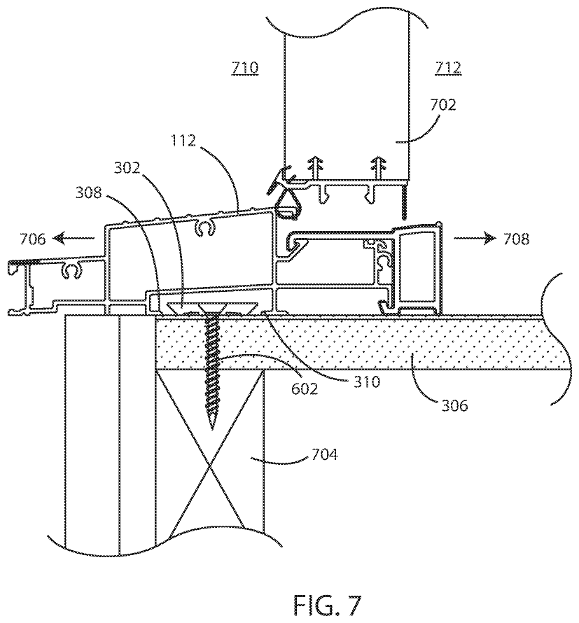

Referring now to FIG. 7, a schematic side view of components of a fenestration system 100 is shown in accordance with various embodiments herein. This view is consistent with a door system. However, similar features can be included with a window system. A fenestration system includes a sill cleat 302 secured to a base structure 306 and a rim joint 704 with a fastener 602. The fenestration system also includes a door panel 702. The fenestration system also includes an exterior side 710 and an interior side 712. The sill assembly 112 includes a first edge projection 308 and a second edge projection 310. FIG. 7 shows a first direction 706 and a second direction 708. The first edge projection 308 and the second edge projection 310 can engage with the sill cleat 302 to limit or prevent lateral movement of the sill assembly 112 in the first direction 706 and the second direction 708. However, beyond lateral movement, the sill may also be subject to forces that may otherwise cause it to rotate or move up and down based on loading conditions. The embodiments of sill cleats herein are designed to engage with the sill and prevent lifting of the sill. Further, in various embodiments herein engagement of the sill with the sill cleat 302 can translate forces on the sill into a downward direction onto an underlying structure causing further reinforcement of the sill.

In some embodiments, sill cleats herein can be used with fenestration systems in the form of entry doors. However, in other embodiments, sill cleats herein can be used with windows. Referring now to FIG. 8, a schematic side view of components of a fenestration system is shown in accordance with various embodiments herein. As before, the fenestration system includes a sill cleat 302. The sill cleat 302 can be fastened with a fastener 602 down to a base surface 304. The sill cleat 302 includes a first angled surface 402 and a second angled surface 404. In this example, however, the sill is a gliding window sill 202. The gliding window sill 202 can include a bottom side including a first edge projection 308 and a second edge projection 310.

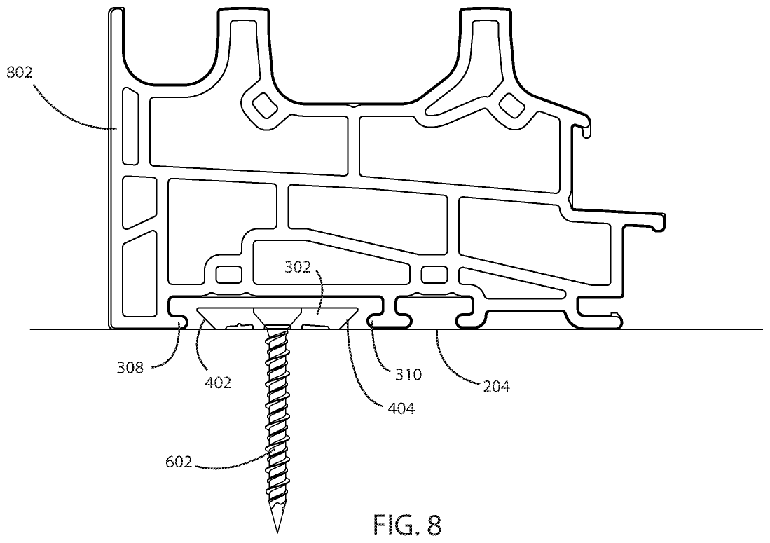

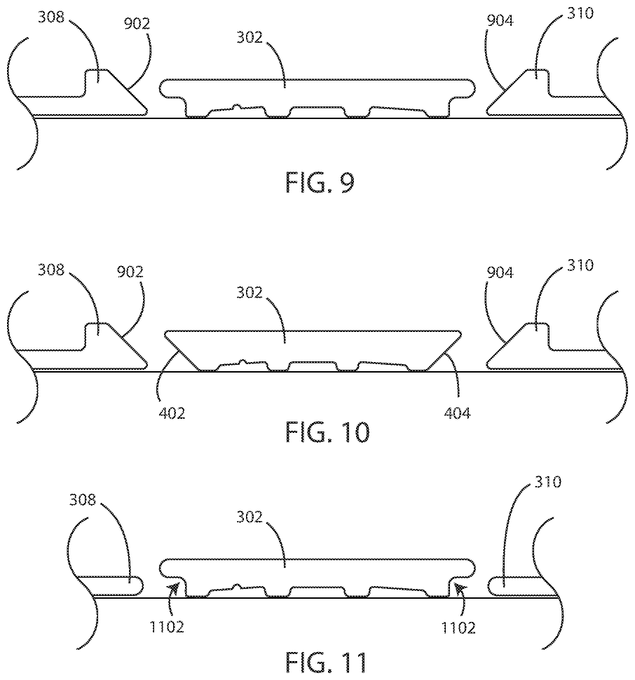

In some embodiments, the edge projections of the sill assembly can include an angled surface in addition to or instead of the angled surfaces on the sill cleat. Referring now to FIG. 9, a schematic side view of components of a fenestration system is shown in accordance with various embodiments herein. As before, a sill cleat 302 is included, but in this embodiment the sill cleat 302 lacks angled surfaces on the edges thereof. Rather, the first edge projection 308 includes a first projection angled surface 902. Further, the second edge projection 310 includes a second projection angled surface 904. The first angled surface 902 of the first edge projection 308 can be configured to engage the sill cleat 302 upon movement of the sill in a first direction. The second angled surface 904 of the second edge projection 310 can be configured to engage the sill cleat 302 upon movement of the sill in a second direction.

In some embodiments, both the edge projections of the sill and the edges of the sill cleat can include angled surfaces. Referring now to FIG. 10, a schematic side view of components of a fenestration system 100 is shown in accordance with various embodiments herein. The sill cleat 302 includes a first angled surface 402 and a second angled surface 404. The first edge projection 308 of the sill assembly includes a first projection angled surface 902. The second edge projection 310 of the sill assembly includes a second projection angled surface 904. The first angled surface 402 of the sill cleat 302 can be configured to engage the first projection angled surface 902 upon movement of the sill assembly in a first direction. Similarly, the second angled surface 404 of the sill cleat 302 can be configured to engage the second projection angled surface 904 of the of the second edge projection 310 upon movement of the sill cleat in a second direction.

In some embodiments, angled surfaces such as those shown in other views herein may be omitted. For example, in some embodiments, the sill cleat and the edge projections of the sill can include structural features causing them to interlock. Referring now to FIG. 11, a schematic side view of components of a fenestration system 100 is shown in accordance with various embodiments herein. The sill cleat 302 includes undercut portions 1102 near the edges thereof. The undercut portions 1102 are sized to receive the edge projections 308, 310 of the sill assembly.

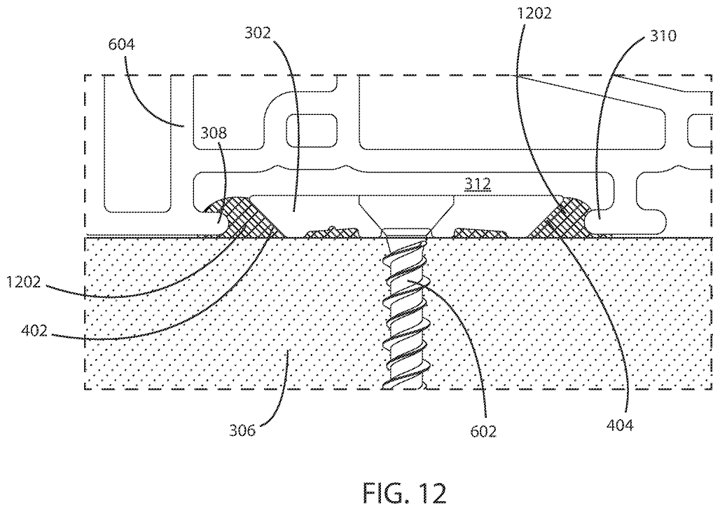

Referring now to FIG. 12, a schematic side view of components of a fenestration system is shown in accordance with various embodiments herein. The fenestration system includes a sill assembly including an extrusion 604. As before, the sill cleat 302 includes a first angled surface 402 and a second angled surface 404. The fenestration system also includes a fastener 602 securing the sill cleat 302 to a base structure 306. The bottom side of the sill assembly includes a first edge projection 308 and a second edge projection 310 and defines a cavity 312 into which the sill cleat 302 can fit.

In this embodiment, the fenestration system also includes a polymeric composition 1202. In various embodiments, the polymeric composition 1202 can be disposed adjacent to a first angled surface 402 and a second angled surface 404. The polymeric composition 1202 can include various materials. In some embodiments, the polymeric composition 1202 can include an elastomeric composition. In some embodiments, the polymeric composition 1202 can include a silicone sealant. While not intending to be bound by theory, the polymeric composition 1202 can take up the space of some gaps and further constrain movement of the sill. In some embodiments, the polymeric composition 1202 can provide a damping effect on movement of the sill. The polymer composition 1202 can also aid in providing sealing and/or providing additional retention strength.

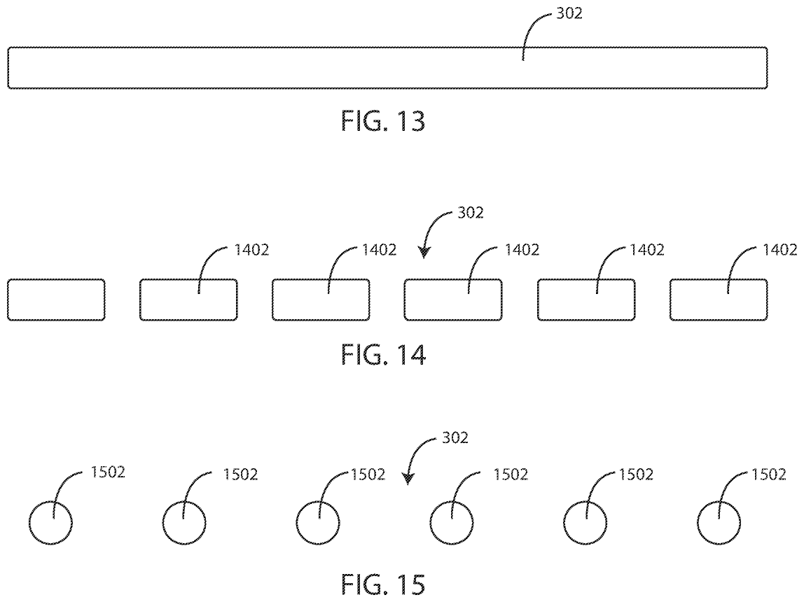

Referring now to FIG. 13, a plan view is shown of a sill cleat 302 in accordance with various embodiments herein. In this example, the sill cleat 302 is a unitary structure. Also, in this example the sill cleat has a substantially rectangular perimeter. However, many other perimeter shapes are contemplated herein. In various embodiments, the sill cleat 302 can be at least 6, 10, 18, 24, 36, or 48 inches long, or a length falling within a range between any of the foregoing. Further, it will be appreciated that in various embodiments the sill cleat 302 can be divided into a plurality of discrete pieces. Referring now to FIG. 14, a plan view is shown of a sill cleat 302 in accordance with various embodiments herein. In this example, the sill cleat 302 is divided into a number of discrete pieces 1402.

As referenced above, many different shapes of sill cleats are contemplated herein. Referring now to FIG. 15, a plan view is shown of a sill cleat 302 in accordance with various embodiments herein. In this example, the sill cleat 302 is divided into a number of portions 1502 that each have a substantially circular perimeter. Many other shapes for sill cleat perimeters are contemplated herein including polygonal, oval, curvilinear, irregular, and the like.

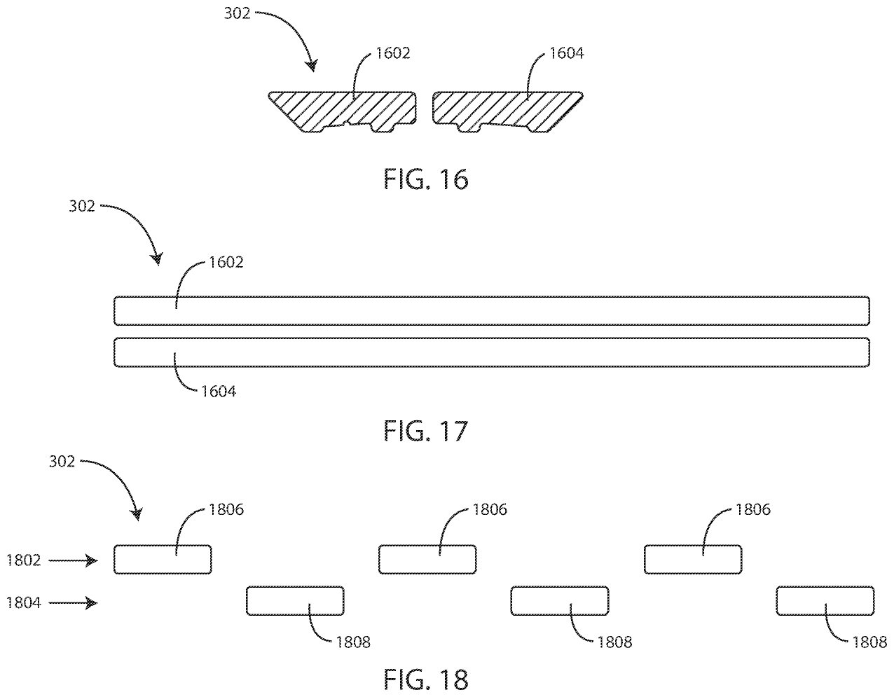

In various embodiments, the sill cleat can be a unitary structure in cross-section. However, in some embodiments, the sill cleat can be a non-unitary structure. For example, the sill cleat can take the form of two or more discrete components in cross-section. Referring now to FIG. 16, a cross-sectional view of a sill cleat 302 is shown in accordance with various embodiments herein. In this example, the sill cleat 302 is non-unitary. In specific, the sill cleat 302 is divided into a first portion 1602 and a second portion 1604 (which may correspond to exterior and interior portions or vice versa). The sill cleat 302 can include features as described elsewhere herein. In some embodiments, the sill cleat 302 can be divided into more than two portions. Referring now to FIG. 17, a plan view of a sill cleat 302 is shown in accordance with various embodiments herein. In specific, FIG. 17 shows a plan view of a non-unitary sill cleat 302 including a first portion 1602 and a second portion 1604.

In some embodiments, a sill cleat herein can be asymmetrical in cross-section. For example, in some embodiments, a sill cleat herein may only include an angled surface or interlocking structure on one edge or the other. For example, in some embodiments, a sill cleat can take the form of either the first portion 1602 or the second portion 1604 of FIG. 16, without the other portion.

Referring now to FIG. 18, a plan view of a sill cleat 302 is shown in accordance with various embodiments herein. In this example, the sill cleat 302 is divided into a plurality of first portions 1806 and a plurality of second portions 1808. The first portions 1806 may be aligned on an interior side 1802 while the second portions may be aligned on an exterior side 1804 (or vice versa). In this case, the first portions 1806 and the second portions 1808 are offset from one another along their length, however they may also be aligned.

### Methods

Many different methods are contemplated herein, including, but not limited to, methods of making, methods of using, and the like. Aspects of system/device operation described elsewhere herein can be performed as operations of one or more methods in accordance with various embodiments herein.

In an embodiment, a method of securing a sill of a fenestration system is included herein. The method can include attaching a sill cleat to a base structure. The sill cleat can include a first angled surface and a second angled surface. The method can further include mounting a sill assembly over the sill cleat. The sill assembly can include a bottom side. The bottom side can include a first edge projection a second edge projection. The bottom side can define a cavity. The sill cleat can fit within a gap between the first edge projection and the second edge projection.

In an embodiment of the method, the first angled surface is configured to engage the first edge projection upon movement of the sill assembly in a first direction a distance of 0.1 to 0.3 inches. In an embodiment of the method, the first angled surface is configured to engage the first edge projection upon movement of the sill assembly in a first direction a distance of 0.175 inches.

In an embodiment of the method, the first angled surface is angled from 35 to 55 degrees with respect to a bottom side of the sill assembly such that a top of the first angled surface is wider than a bottom of the first angled surface.

In an embodiment of the method, the second angled surface is configured to engage the second edge projection upon movement of the sill assembly in a second direction a distance of 0.1 to 0.3 inches. In an embodiment of the method, the second angled surface is configured to engage the second edge projection upon movement of the sill assembly in a second direction a distance of 0.175 inches.

In an embodiment of the method, the second angled surface is angled from 35 to 55 degrees with respect to a bottom side of the sill assembly.

In an embodiment, a method of securing a sill of a fenestration system is included, the method including attaching a sill cleat to a base structure. The method further includes mounting a sill assembly over the sill cleat. The sill assembly can include a bottom surface. The bottom surface can include a first edge projection. The first edge projection can include a first angled surface. The bottom surface can include a second edge projection. The second edge projection can include a second angled surface. The bottom surface defines a cavity. The sill cleat fits within a gap between the first edge projection and the second edge projection.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as arranged and configured, constructed and arranged, constructed, manufactured and arranged, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

As used herein, the recitation of numerical ranges by endpoints shall include all numbers subsumed within that range (e.g., 2 to 8 includes 2.1, 2.8, 5.3, 7, etc.).

The headings used herein are provided for consistency with suggestions under 37 CFR 1.77 or otherwise to provide organizational cues. These headings shall not be viewed to limit or characterize the invention(s) set out in any claims that may issue from this disclosure. As an example, although the headings refer to a “Field,” such claims should not be limited by the language chosen under this heading to describe the so-called technical field. Further, a description of a technology in the “Background” is not an admission that technology is prior art to any invention(s) in this disclosure. Neither is the “Summary” to be considered as a characterization of the invention(s) set forth in issued claims.

The embodiments described herein are not intended to be exhaustive or to limit the invention to the precise forms disclosed in the following detailed description. Rather, the embodiments are chosen and described so that others skilled in the art can appreciate and understand the principles and practices. As such, aspects have been described with reference to various specific and preferred embodiments and techniques. However, it should be understood that many variations and modifications may be made while remaining within the spirit and scope herein.

1. A fenestration system comprising:
a frame assembly, the frame assembly comprising
a sill, the sill comprising
a bottom surface, the bottom surface comprising
a first edge projection;
a second edge projection; and
the bottom surface defining a cavity, wherein a gap between the first edge projection and the second edge projection provides access to the cavity;
a sill cleat, the sill cleat comprising
a first angled surface, wherein the first angled surface is configured to engage the first edge projection upon movement of the sill in a first direction; and
a second angled surface;
wherein the second angled surface is disposed on an opposite side of the sill cleat from the first angled surface;
wherein the second angled surface is configured to engage the second edge projection upon movement of the sill in a second direction;
wherein the sill cleat extends part way through the gap; and
wherein the first direction is opposite the second direction.

2. The fenestration system of claim 1, wherein the first angled surface is configured to engage the first edge projection upon movement of the sill in the first direction a distance of 0.1 to 0.3 inches.

3. The fenestration system of claim 1, wherein the first angled surface is configured to engage the first edge projection upon movement of the sill in the first direction a distance of 0.175 inches.

4. The fenestration system of claim 1, wherein the second angled surface is configured to engage the second edge projection upon movement of the sill in the second direction a distance of 0.1 to 0.3 inches.

5. The fenestration system of claim 1, wherein the second angled surface is configured to engage the second edge projection upon movement of the sill in the second direction a distance of 0.175 inches.

6. The fenestration system of claim 1, further comprising a polymeric composition, wherein the polymeric composition is disposed adjacent to the first angled surface and the second angled surface.

7. (canceled)

8. The fenestration system of claim 1, wherein the first angled surface is angled from 35 to 55 degrees with respect to a bottom surface of the sill such that a top of the first angled surface is wider than a bottom of the first angled surface.

9. The fenestration system of claim 1, wherein the second angled surface is angled from 35 to 55 degrees with respect to a bottom surface of the sill.

10. The fenestration system of claim 1, wherein the fenestration system is a door assembly.

11. The fenestration system of claim 1, wherein the fenestration system is a window assembly.

12. The fenestration system of claim 1, wherein the sill cleat has a profile height of about ⅜ inches or less.

13-14. (canceled)

15. The fenestration system of claim 1, wherein the sill cleat is formed of aluminum.

16. The fenestration system of claim 1, wherein the sill cleat is at least 10 inches long.

17. The fenestration system of claim 1, wherein a bottom surface of the sill cleat defines one or more feet.

18. The fenestration system of claim 1, wherein the sill cleat is divided into a plurality of discrete pieces.

19. The fenestration system of claim 1, wherein the sill cleat has a substantially rectangular perimeter.

20. The fenestration system of claim 1, wherein the sill cleat has a substantially circular perimeter.

21. The fenestration system of claim 1, wherein the sill cleat has a curvilinear perimeter.

22-26. (canceled)

27. A fenestration system comprising:
a frame assembly, the frame assembly comprising
a sill, the sill comprising
a bottom surface, the bottom surface comprising
a first edge projection, the first edge projection comprising a first angled surface;
a second edge projection, the second edge projection comprising a second angled surface;
the bottom surface defining a cavity, wherein a gap between the first edge projection and the second edge projection provides access to the cavity;
a sill cleat;
wherein the sill cleat extends part way through the gap;
wherein the first angled surface of the first edge projection is configured to engage the sill cleat upon movement of the sill in a first direction;
wherein the second angled surface of the second edge projection is configured to engage the sill cleat upon movement of the sill in a second direction; and
wherein the first direction is opposite the second direction.

28-46. (canceled)

47. A fenestration system comprising:
a frame assembly, the frame assembly comprising
a sill, the sill comprising
a bottom surface, the bottom surface comprising
a first edge projection;
a second edge projection; and
the bottom surface defining a cavity, wherein a gap between the first edge projection and the second edge projection provides access to the cavity;
a sill cleat, the sill cleat comprising a first angled surface, wherein the first angled surface is configured to engage the first edge projection upon movement of the sill in a first direction; and
wherein the sill cleat extends part way through the gap.

48-81. (canceled)

1. A fenestration system comprising:
a frame assembly, the frame assembly comprising
a sill, the sill comprising
a bottom surface, the bottom surface comprising
a first edge projection;
a second edge projection; and
the bottom surface defining a cavity, wherein a gap between the first edge projection and the second edge projection provides access to the cavity;
a sill cleat, the sill cleat comprising
a first angled surface, wherein the first angled surface is configured to engage the first edge projection upon movement of the sill in a first direction; and
a second angled surface;
wherein the second angled surface is disposed on an opposite side of the sill cleat from the first angled surface;
wherein the second angled surface is configured to engage the second edge projection upon movement of the sill in a second direction;
wherein the sill cleat extends part way through the gap; and
wherein the first direction is opposite the second direction.

2. The fenestration system of claim 1, wherein the first angled surface is configured to engage the first edge projection upon movement of the sill in the first direction a distance of 0.1 to 0.3 inches.

3. The fenestration system of claim 1, wherein the first angled surface is configured to engage the first edge projection upon movement of the sill in the first direction a distance of 0.175 inches.

4. The fenestration system of claim 1, wherein the second angled surface is configured to engage the second edge projection upon movement of the sill in the second direction a distance of 0.1 to 0.3 inches.

5. The fenestration system of claim 1, wherein the second angled surface is configured to engage the second edge projection upon movement of the sill in the second direction a distance of 0.175 inches.

6. The fenestration system of claim 1, further comprising a polymeric composition, wherein the polymeric composition is disposed adjacent to the first angled surface and the second angled surface.

7. The fenestration system of claim 6, the polymeric composition comprising a silicone sealant.

8. The fenestration system of claim 1, wherein the first angled surface is angled from 35 to 55 degrees with respect to a bottom surface of the sill such that a top of the first angled surface is wider than a bottom of the first angled surface.

9. The fenestration system of claim 1, wherein the second angled surface is angled from 35 to 55 degrees with respect to a bottom surface of the sill.

10. The fenestration system of claim 1, wherein the fenestration system is a door assembly.

11. The fenestration system of claim 1, wherein the fenestration system is a window assembly.

12. The fenestration system of claim 1, wherein the sill cleat has a profile height of about ⅜ inches or less.

13. The fenestration system of claim 1, wherein the sill cleat is formed of an injection molded polymer.

14. The fenestration system of claim 1, wherein the sill cleat is formed of a metal.

15. The fenestration system of claim 1, wherein the sill cleat is formed of aluminum.

16. The fenestration system of claim 1, wherein the sill cleat is at least 10 inches long.

17. The fenestration system of claim 1, wherein a bottom surface of the sill cleat defines one or more feet.

18. The fenestration system of claim 1, wherein the sill cleat is divided into a plurality of discrete pieces.

19. The fenestration system of claim 1, wherein the sill cleat has a substantially rectangular perimeter.

20. The fenestration system of claim 1, wherein the sill cleat has a substantially circular perimeter.

21. The fenestration system of claim 1, wherein the sill cleat has a curvilinear perimeter.

22. A method of securing a sill of a fenestration system comprising:
attaching a sill cleat to a base structure, the sill cleat comprising
a first angled surface; and
a second angled surface;
mounting a sill assembly over the sill cleat, the sill assembly comprising
a bottom surface, the bottom surface comprising
a first edge projection;
a second edge projection; and
the bottom surface defining a cavity, wherein the sill cleat fits within a gap between the first edge projection and the second edge projection.

23. The method of claim 22, wherein the first angled surface is configured to engage the first edge projection upon movement of the sill assembly in a first direction a distance of 0.1 to 0.3 inches.

24. The method of claim 22, wherein the first angled surface is angled from 35 to 55 degrees with respect to a bottom surface of the sill assembly such that a top of the first angled surface is wider than a bottom of the first angled surface.

25. The method of claim 22, wherein the second angled surface is configured to engage the second edge projection upon movement of the sill assembly in a second direction a distance of 0.1 to 0.3 inches.

26. The method of claim 22, wherein the second angled surface is angled from 35 to 55 degrees with respect to a bottom surface of the sill assembly.

27. A fenestration system comprising:
a frame assembly, the frame assembly comprising
a sill, the sill comprising
a bottom surface, the bottom surface comprising
a first edge projection, the first edge projection comprising a first angled surface;
a second edge projection, the second edge projection comprising a second angled surface;
the bottom surface defining a cavity, wherein a gap between the first edge projection and the second edge projection provides access to the cavity;
a sill cleat;
wherein the sill cleat extends part way through the gap;
wherein the first angled surface of the first edge projection is configured to engage the sill cleat upon movement of the sill in a first direction;
wherein the second angled surface of the second edge projection is configured to engage the sill cleat upon movement of the sill in a second direction; and
wherein the first direction is opposite the second direction.

28. The fenestration system of claim 27, wherein the first angled surface is configured to engage the sill cleat upon movement of the sill in the first direction a distance of 0.175 inches.

29. The fenestration system of claim 27, wherein the second angled surface is configured to engage the sill cleat upon movement of the sill in the second direction a distance of 0.175 inches.

30. The fenestration system of claim 27, further comprising a polymeric composition, wherein the polymeric composition is disposed adjacent to the first angled surface and the second angled surface.

31. The fenestration system of claim 30, the polymeric composition comprising a silicone sealant.

32. The fenestration system of claim 27, wherein the first angled surface is angled from 35 to 55 degrees with respect to a bottom surface of the sill.

33. The fenestration system of claim 27, wherein the second angled surface is angled from 35 to 55 degrees with respect to a bottom surface of the sill.

34. The fenestration system of claim 27, wherein the fenestration system is a door assembly.

35. The fenestration system of claim 27, wherein the fenestration system is a window assembly.

36. The fenestration system of claim 27, wherein the sill cleat has a profile height of about ⅜ inches or less.

37. The fenestration system of claim 27, wherein the sill cleat is formed of an injection molded polymer.

38. The fenestration system of claim 27, wherein the sill cleat is formed of a metal.

39. The fenestration system of claim 27, wherein the sill cleat is formed of aluminum.

40. The fenestration system of claim 27, wherein the sill cleat is at least 10 inches long.

41. The fenestration system of claim 27, wherein a bottom surface of the sill cleat defines one or more feet.

42. A method of securing a sill of a fenestration system comprising:
attaching a sill cleat to a base structure; and
mounting a sill assembly over the sill cleat, the sill assembly comprising
a bottom surface, the bottom surface comprising
a first edge projection, the first edge projection comprising a first angled surface;
a second edge projection, the second edge projection comprising a second angled surface; and
the bottom surface defining a cavity, wherein the sill cleat fits within a gap between the first edge projection and the second edge projection.

43. The method of claim 42, wherein the first angled surface is configured to engage the sill cleat upon movement of the sill assembly in a first direction a distance of 0.1 to 0.3 inches.

44. The method of claim 42, wherein the first angled surface is angled from 35 to 55 degrees with respect to a bottom surface of the sill assembly.

45. The method of claim 42, wherein the second angled surface is configured to engage the sill cleat upon movement of the sill assembly in a second direction a distance of 0.1 to 0.3 inches.

46. The method of claim 42, wherein the second angled surface is angled from 35 to 55 degrees with respect to a bottom surface of the sill assembly.

47. A fenestration system comprising:
a frame assembly, the frame assembly comprising
a sill, the sill comprising
a bottom surface, the bottom surface comprising
a first edge projection;
a second edge projection; and
the bottom surface defining a cavity, wherein a gap between the first edge projection and the second edge projection provides access to the cavity;
a sill cleat, the sill cleat comprising a first angled surface, wherein the first angled surface is configured to engage the first edge projection upon movement of the sill in a first direction; and
wherein the sill cleat extends part way through the gap.

48. The fenestration system of claim 47, wherein the first angled surface is configured to engage the first edge projection upon movement of the sill in the first direction a distance of 0.1 to 0.3 inches.

49. The fenestration system of claim 47, wherein the first angled surface is configured to engage the first edge projection upon movement of the sill in the first direction a distance of 0.175 inches.

50. The fenestration system of claim 47, further comprising a polymeric composition, wherein the polymeric composition is disposed adjacent to the first angled surface.

51. The fenestration system of claim 50, the polymeric composition comprising a silicone sealant.

52. The fenestration system of claim 47, wherein the first angled surface is angled from 35 to 55 degrees with respect to a bottom surface of the sill such that a top of the first angled surface is wider than a bottom of the first angled surface.

53. The fenestration system of claim 47, wherein the fenestration system is a door assembly.

54. The fenestration system of claim 47, wherein the fenestration system is a window assembly.

55. The fenestration system of claim 47, wherein the sill cleat has a profile height of about ⅜ inches or less.

56. The fenestration system of claim 47, wherein the sill cleat is formed of an injection molded polymer.

57. The fenestration system of claim 47, wherein the sill cleat is formed of a metal.

58. The fenestration system of claim 47, wherein the sill cleat is formed of aluminum.

59. The fenestration system of claim 47, wherein the sill cleat is at least 10 inches long.

60. The fenestration system of claim 47, wherein a bottom surface of the sill cleat defines one or more feet.

61. The fenestration system of claim 47, wherein the sill cleat is divided into a plurality of discrete pieces.

62. The fenestration system of claim 47, wherein the sill cleat has a substantially rectangular perimeter.

63. The fenestration system of claim 47, wherein the sill cleat has a substantially circular perimeter.

64. The fenestration system of claim 47, wherein the sill cleat has a curvilinear perimeter.

65. A fenestration system comprising:
a frame assembly, the frame assembly comprising
a sill, the sill comprising
a bottom surface, the bottom surface comprising
a first edge projection;
a second edge projection; and
the bottom surface defining a cavity, wherein a gap between the first edge projection and the second edge projection provides access to the cavity;
a sill cleat, the sill cleat comprising
a first undercut portion, wherein the first undercut portion is configured to engage the first edge projection upon movement of the sill in a first direction; and
a second undercut portion;
wherein the second undercut portion is disposed on an opposite side of the sill cleat from the first undercut portion;
wherein the second undercut portion is configured to engage the second edge projection upon movement of the sill in a second direction;
wherein the sill cleat extends part way through the gap; and
wherein the first direction is opposite the second direction.

66. The fenestration system of claim 65, wherein the first undercut portion is configured to engage the first edge projection upon movement of the sill in the first direction a distance of 0.1 to 0.3 inches.

67. The fenestration system of claim 65, wherein the second undercut portion is configured to engage the second edge projection upon movement of the sill in the second direction a distance of 0.1 to 0.3 inches.

68. The fenestration system of claim 65, further comprising a polymeric composition, wherein the polymeric composition is disposed adjacent to the first undercut portion and the second undercut portion.

69. The fenestration system of claim 68, the polymeric composition comprising a silicone sealant.

70. The fenestration system of claim 65, wherein the fenestration system is a door assembly.

71. The fenestration system of claim 65, wherein the fenestration system is a window assembly.

72. The fenestration system of claim 65, wherein the sill cleat has a profile height of about ⅜ inches or less.

73. The fenestration system of claim 65, wherein the sill cleat is formed of an injection molded polymer.

74. The fenestration system of claim 65, wherein the sill cleat is formed of a metal.

75. The fenestration system of claim 65, wherein the sill cleat is formed of aluminum.

76. The fenestration system of claim 65, wherein the sill cleat is at least 10 inches long.

77. The fenestration system of claim 65, wherein a bottom surface of the sill cleat defines one or more feet.

78. The fenestration system of claim 65, wherein the sill cleat is divided into a plurality of discrete pieces.

79. The fenestration system of claim 65, wherein the sill cleat has a substantially rectangular perimeter.

80. The fenestration system of claim 65, wherein the sill cleat has a substantially circular perimeter.

81. The fenestration system of claim 65, wherein the sill cleat has a curvilinear perimeter.
